(19) United States
(12) Patent Application Publication
(10) Pub. No.: US 2023/0068609 A1
(43) Pub. Date: Mar. 2, 2023

(54) SYSTEM AND DEVICE FOR VEHICLE COMMUNICATION

(71) Applicant: DANLAW, INC., NOVI, MI (US)

(72) Inventors: Andrew DONALDSON, West Bloomfield, MI (US); Scott MORELL, Traverse City, MI (US)

(73) Assignee: DANLAW, INC., NOVI, MI (US)

(21) Appl. No.: 17/891,902

(22) Filed: Aug. 19, 2022

Related U.S. Application Data
(60) Provisional application No. 63/236,724, filed on Aug. 25, 2021.

(51) Int. Cl. H01Q 1/32; H04W 4/40; H04W 4/80

(52) U.S. Cl. CPC H01Q 1/3291; H04W 4/40; H04W 4/80

(57) ABSTRACT

A system for vehicle communications of a vehicle includes a housing, a processor, and an antenna electrically connected to the processor. The processor is adapted to generate and also receive communication messages external to the vehicle, and the antenna in communication with the processor is adapted to transmit and receive the communication messages for a Vehicle to Everything (V2X) communication. In the vehicle communication system, the antenna is attached to the housing, which is mounted on the interior side of the vehicle such that the vehicle communication system transmit or receive one or more radio frequency signals to or from the one or more antennas placed inside the vehicle.

### CROSS-REFERENCE TO RELATED APPLICATIONS

This application claims the benefit of priority under 35 U.S.C. § 119 to U.S. Provisional Patent Application No. 63/236,724, filed Aug. 25, 2021, the contents of which are incorporated herein by reference in their entirety.

### FIELD

The present disclosure relates to a vehicle communication system that communicates a signal via a vehicle communication device attached to a vehicle.

### BACKGROUND

The statements in this section merely provide background information related to the present disclosure and may not constitute prior art.

Many vehicles include an antenna used for wireless communication performed with, for example, a wireless communication base station. In order for a vehicle to maintain a satisfactory communication state while traveling where the communication environment constantly changes, there is a demand for a vehicle antenna that has an improved function and also is mounted to a better location on the vehicle for maintaining communication. Accordingly, the vehicle antenna is generally installed or mounted on an exterior vehicle surface such as the roof, trunk, or windshield of the vehicle to have unobstructed signals for having the better wireless communication.

For the best performance of the system, current state-of-the-art Vehicle to Everything (V2X) communication systems use a roof mounted antenna and achieve excellent communication robustness. Such antennas must be mounted to the exterior to ensure a sufficient signal can be transmitted and received in all directions for vehicle communications. The antenna mounted on the exterior vehicle surface may be connected to one or more electronic devices (e.g., a radio receiver, a touchscreen display, a navigation device, etc.) inside the vehicle such that the antenna is operable to transmit and/or receive signals to/from the electronic devices inside the vehicle. However, the roof mounted antenna and the electronic devices need to be connected each other for the communication such that the vehicle communication system would require drilling holes to make the connections in the existing aftermarket vehicles or wireless communication between two devices (e.g., the external antenna and the electronic device inside the vehicle) separately mounted on the vehicle exterior surface and also the vehicle interior surface, respectively.

### SUMMARY

The present disclosure relates to a vehicle communication system that communicates a signal via a vehicle communication device. In particular, the vehicle communication system according to the present disclosure includes a housing, a processor for generating and receiving communication messages external to the vehicle, a Vehicle to Everything (V2X) transceiver electrically connected to the processor, and at least one antenna electrically connected to the V2X transceiver to transmit and receive radio frequency (RF) signals outside the vehicle. The V2X transceiver is in communication with the processor to transmit and receive the communication messages for a Vehicle to Everything (V2X) communication, and the at least one V2X antenna is arranged in the housing which is located in an interior side of the vehicle. The vehicle communication system of the present disclosure is easily installed in the vehicle such that the installation cost and/or time of the vehicle communication system is reduced.

According to a further aspect of the present disclosure, the at least one V2X antenna is placed and enclosed in the housing. Further, the housing is mounted at a location inside the vehicle, preferably to a front windshield, a rear windshield, a top surface of a dashboard, or a top surface of a parcel shelf inside the vehicle.

According to a further aspect of the present disclosure, the processor is located inside the housing and configured to communicate with externals to the vehicle through the at least one antenna located inside the housing. The housing further includes a second antenna such that the processor is electrically connected to a second transceiver configured to communicate messages from the second antenna to a wireless connection with an infotainment system of the vehicle. The wireless connection with the vehicle infotainment system is over a Bluetooth connection and/or a Wi-Fi connection.

According to a further aspect of the present disclosure, a central processing unit (CPU) of the vehicle is used as the processor of the vehicle communication device such that the V2X antenna transceiver is communicated with an external electronic control unit (ECU) as the processor in the CPU.

According to a further aspect of the present disclosure, the vehicle communication system further includes a vehicle interface connector formed in the housing, and the interface connector is configured to communicate with an infotainment system of the vehicle via a wired connection.

According to a further aspect of the present disclosure, the processor is configured to generate the RF signals within frequency ranges of 5.70 and 5.95 Hz.

According to a further aspect of the present disclosure, the housing further includes a display for communicating with a user.

According to a further aspect of the present disclosure, the vehicle communication system further includes a Global Navigation Satellite System (GNSS) antenna arranged in the housing, and the GNSS antenna is configured to be operable for receiving and transmitting GNSS signals. Further, the system further includes a cellular Long Term Evolution (LTE) antenna arranged in the housing, and the cellular LTE antenna is configured to be operable for receiving and transmitting LTE signals.

According to a further aspect of the present disclosure, the system further includes a 4G or 5G cellular module arranged in the housing, and the 4G or 5G cellular module is configured to be operable for receiving and transmitting cellular 4G or 5G signals.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a side view of a vehicle having a vehicle communication system in accordance with an exemplary form of the present disclosure, FIG. 1A shows the vehicle communication system mounted in a front windshield inside the vehicle of FIG. 1, and FIG. 1B shows the vehicle communication system mounted in a dashboard inside the vehicle of FIG. 1;

FIG. 2 shows a side view of a vehicle having a vehicle communication system in accordance with an exemplary form of the present disclosure, FIG. 2A shows the vehicle communication system mounted behind a rear windshield inside the vehicle of FIG. 2, and FIG. 2B shows the vehicle communication system mounted in a parcel shelf inside the vehicle of FIG. 2;

FIG. 3 shows a structure block diagram of a vehicle communication device mounted to an interior side of the vehicle of FIGS. 1 and 2, and FIG. 3A a structure block diagram of a vehicle communication device in accordance with another exemplary form of the present disclosure; and

FIG. 4 shows a block diagram of the vehicle communication system with an integrated processor of FIGS. 1 and 2.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

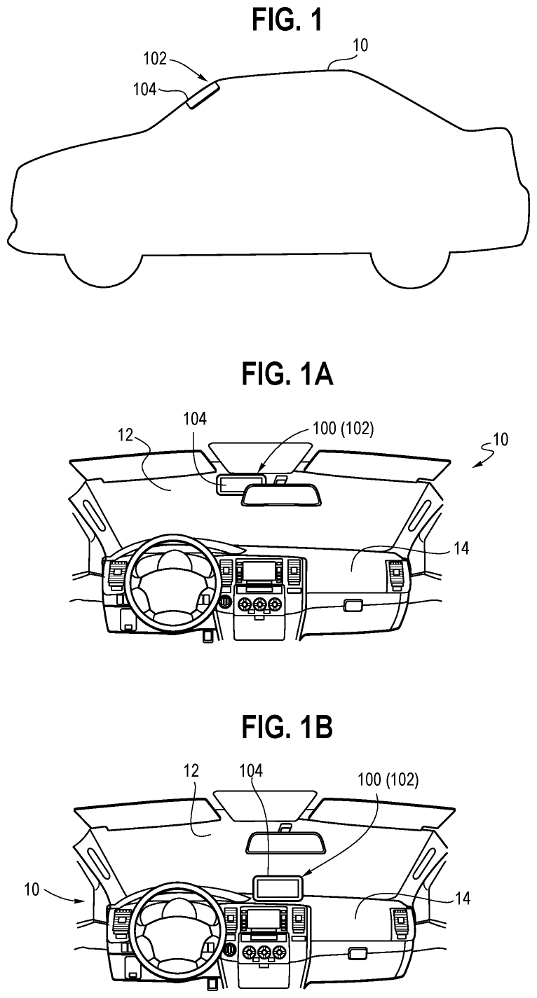

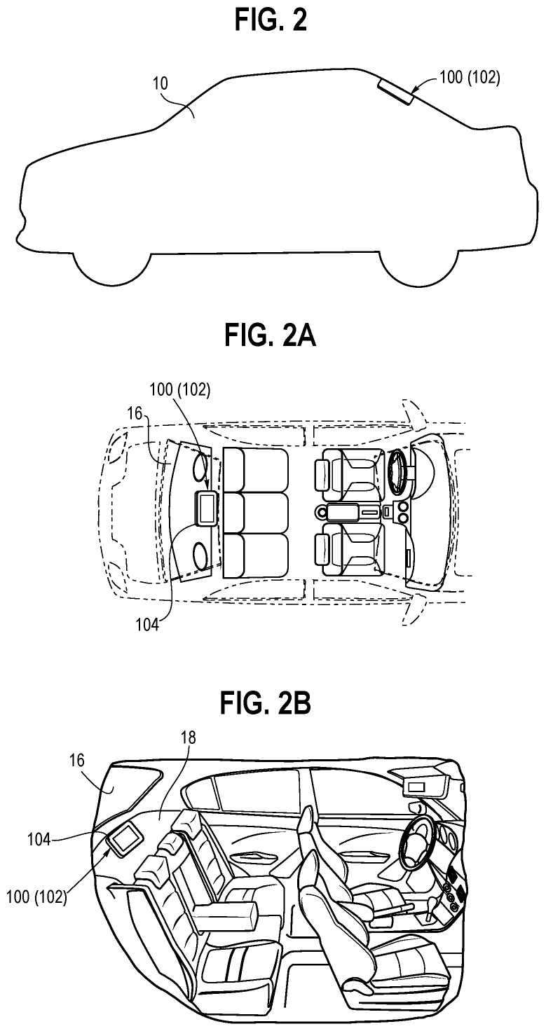

A vehicle communication device for a communication system of a vehicle includes various antennas having current state-of-the-art Vehicle to Everything (V2X) antennas, cellular antennas, and Global Navigation Satellite System (GNSS) antennas, etc. In such exemplary embodiments, a V2X solution may be integrated or included in the vehicle communication device, which provides a user with more versatility in communication and aftermarket installation. The communication system for the vehicle generally includes V2X functionality or connectivity. The V2X connectivity may allow vehicles to communicate with each other (Vehicle-to-Vehicle (V2V)) and allow vehicles to communicate with infrastructure (Vehicle-to-Infrastructure (V2I)). In an exemplary embodiment of FIGS. 1 and 2, the vehicle communication device 102 including at least one integrated antennas 106 for using in the vehicle communication system 100 is placed inside the vehicle 10. We have discovered that, when properly located within the vehicle and tuned, the vehicle communication device 102 can be mounted inside the vehicle. In particular, our tests show that the interior mounted communication system 100, when configured as described below, achieves acceptable communication range and direction, both to the front, rear and sides of the vehicle while the vehicle is moving. This range of the at least one antenna provides sufficient communications for V2X, including safety systems utilizing the same.

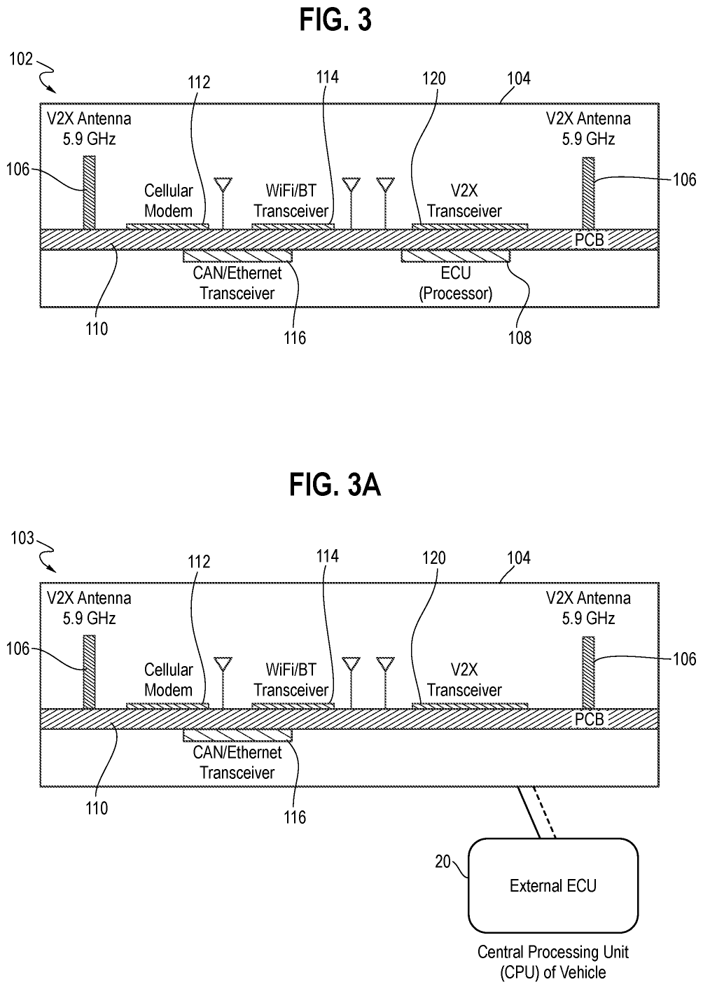

As shown in FIGS. 1 and 2 of the present disclosure, the vehicle communication device 102 is formed with a housing 104 having at least one integrated antenna 106 such as V2X antennas for communicating with externals (see also FIG. 3). The housing 104 of the vehicle communication device 102 used in the vehicle communication system 100 is generally mounted to the inside of the vehicle 10 such that the vehicle communication system 100 for communicating with the externals is located inside the vehicle 10. As shown in FIGS. 1A and 1B, the vehicle communication device 102 in this embodiment is mounted to an inner surface of a front windshield 12 or a dashboard 14 inside the vehicle 10. For example, the vehicle communication device 102 may be located behind or adjacent an interior rear-view mirror (e.g., top area of the front windshield, see FIG. 1A) or may be mounted on the top surface of the dashboard (see FIG. 1B).

Also, as shown in FIGS. 2A and 2B, the vehicle communication device 102 is mounted to an inner surface of a rear windshield 16 or a parcel shelf 18 in the rear side of the vehicle 10. For example, the vehicle communication device 102 may be located in the top area of the rear windshield 16 (FIG. 2A) or may be mounted on the top surface of the parcel shelf 18 (see FIG. 2B). Generally, the housing 104 of the vehicle communication device 102 is attached to the surfaces (e.g., front or rear windshield, dashboard, and parcel shelf, etc.) by an adhesive or other attachment methods such as a structural mounting feature. However, the location of the vehicle communication device 102 is not limited to the specific areas as described above. In accordance with other forms of the present disclosure, the housing 104 of the vehicle communication device 102 may be attached to other areas such as a side window, peripheral edges around each of the windshields, or other structures such as the mount of the rear-view mirror, the A-pillars, the headliner, or roof structures inside the vehicle 10, including sunroofs and moonroofs. In some implementations, the housing 104 may be attached to any window but extend over the roof line of the vehicle 10 (e.g. it may be bent or curved).

The vehicle communication system 100 mounted to the interior of the vehicle 10 includes a processor, V2X radio with 2×(DSRC or CV2X) radio channels, a global navigation satellite system (GNSS) receiver, 6 DoF Inertial Sensor (3× acceleration, 3× gyro, a Cellular modem, a Hardware Security Processor, WiFi or Low Energy Bluetooth HMI interfaces, On-Board Diagnostics (OBD) vehicle interface (Controller Area Network (CAN), ISO9141, J1850, . . . ), Ethernet/USB interfaces, Tone Audio Outputs, and various antennas (including V2X, GNSS, Cellular, WiFi, low energy BT, etc.), which are described below.

The features discussed above may enable a number of applications including V2V Safety Applications such as Forward Collision Warning, Emergency Electronic Brake Light, Intersection Movement Assist, Left Turn Assist, Blind Spot Warning/Lane Change Warning, and Control Loss Warning. Further, the features may also enable V2I applications such as Speed Compliance Warning, Curve Speed Warning, Speed in Work Zone Warning, Red Light Violation Warning, Oversize Vehicle Compliance, Emergency Communications & Evacuation Information, Pedestrian in Intersection warning, Vehicle Turning Right in front of Bus Warning, Icy Road Warning, and Vulnerable Road User Warning. The sensors and OBD connection are available to support Telematics applications such as User Based Insurance, Fleet Management, and Road Usage Charging applications. The connectivity options also allow Secure Over-the-air update and Flexible Vehicle Event Data Recording and Reporting.

The messages received by the V2X antenna 106 inside the vehicle 10 or generated by a processor inside the housing 104 are communicated with the vehicle infotainment system or other vehicle systems for annunciation or display to the occupants via a wired communication medium such as a Human-Machine Interface (HMI) or a wireless communication medium such as a Bluetooth. The vehicle communication system 100 including the V2X antenna 106 may be powered via the vehicle's OBD port or through a wired power cable.

According to an exemplary embodiment of FIG. 1A in the present disclosure, the vehicle communication device 102 is mounted to the inner surface of the front windshield 12 such that the vehicle communication system 100 is located near the interior rear-view mirror of the vehicle 10. As shown in FIG. 1A, the V2X antenna 106 of the vehicle communication system 100 arranged inside the housing 104 of the vehicle communication device 102 is configured to enable communication between the vehicle and infrastructures (V2I) and/or between the vehicle and another vehicle (V2V) (see also FIG. 3). In addition, the processor of the vehicle communication device 102 is configured to communicate with the vehicle infotainment system or other vehicle systems, and also provide V2X cellular connection for software over-the-air (SW OTA) and security credential updates and/or internet access service (e.g. wireless connectivity, internet browsing capability, etc.) to passengers sitting in the vehicle 10. Accordingly, the vehicle communication system 100 located inside the vehicle 10 is as a single system that handles various wireless and/or wired sub-systems to enable a vehicle to have V2X communications, internet connectivity via Wi-Fi or Ethernet, and Bluetooth based vehicle control/monitoring.

Further, the vehicle communication system 100 is relatively easy to install on the vehicle 10 as an aftermarket safety device (ASD) because, in the vehicle communication device 102, the housing 104 including the at least one antenna 106 of the vehicle communication system 100 is formed as a single unit and is easily mounted only in the interior side of the vehicle. As shown in FIGS. 1 and 2, when the vehicle communication system 100 of the present disclosure is used in the vehicle 10, a separate external antenna does not have to be mounted on the external surface of the vehicle 10 because all of the antennas including the V2X antenna 106 is located and integrated inside the housing 104 of the vehicle communication device 102. In accordance with other forms of the present disclosure, the V2X antenna 106 may be attached to the outside of the housing 104 in the vehicle communication device 102, which is arranged inside the vehicle 10.

FIG. 3 is a structure diagram of the vehicle communication device 102 having the at least one V2X antenna 106. In accordance with an exemplary embodiment of FIG. 3 in the present disclosure, the vehicle communication device 102 includes the housing 104, which is located inside the vehicle 10. As shown in FIG. 3, the vehicle communication device 102 further includes a printed circuit board (PCB) 110 having an electronic control unit (ECU) 108, which is enclosed in the housing 104 and is a part of the processor for the vehicle to everything communications. The ECU 108 communicates with other components through a cable or wirelessly. Further, in an exemplary form of FIG. 3, the vehicle communication device 102 includes two V2X antennas 106, a V2X Transceiver 120, a Cellular modem 112 (3G, LTE, 4G, or 5G cellular module), a WiFi/Bluetooth (WiFi/BT) Transceiver 114, and a CAN/Ethernet Transceiver 116, which are each attached to the printed circuit board 110 and also enclosed by the housing 104. Further, the vehicle communication device 102 includes at least one antenna for communication with each of the Cellular modem 112, the WiFi/BT transceiver 114, and the GNSS transceiver.

In accordance with another embodiment of the present disclosure, a vehicle communication device 103 does not have the ECU 108 (processor) configured to generate and receive communication messages for the functional processing. Instead, as shown in FIG. 3A, the vehicle communication device 103 is configured to send and receive the data to and from a central processing unit (CPU) in the vehicle 10 as an external electronic control unit (ECU) 20. Accordingly, the external ECU 20 communicates with the components arranged in the vehicle communication device 103 through a cable or wirelessly and is configured to generate and receive communication messages for the functional processing of the vehicle communication device 102. Further, due to the external ECU 20 for the functional processing of the vehicle communication device 103, the size of the vehicle communication device 103 is reduced and installed in limited spaces (e.g., around windshields) inside the vehicle 10.

As shown in FIGS. 3 and 3A, in particular, the at least one V2X antenna 106, such as a whip antenna, stub antenna, or monopole antenna, is attached to the PCB, and is arranged inside or outside the housing 104. Accordingly, the vehicle communication device 102 and 103 having the V2X antenna 106 located inside the vehicle 10 is configured to transmit the radio frequency signal to the outside of the vehicle 10 for the V2X communication and/or receive the radio frequency signal from the outside of the vehicle 10. The at least one V2X antenna 106 is configured to transmit at a frequency between the range of 5.70 and 5.95 GHz, and more specifically in some applications 5.850 and 5.925 GHz, and yet in some applications 5.725 and 5.850 GHz. However, according to other forms of the present disclosure, the frequency range may be changed or adjusted according to the regulation of each country where the vehicle communication device 102 is used. For example, in Japan, a radio frequency signal, 760 MHz, is used for the V2X communication.

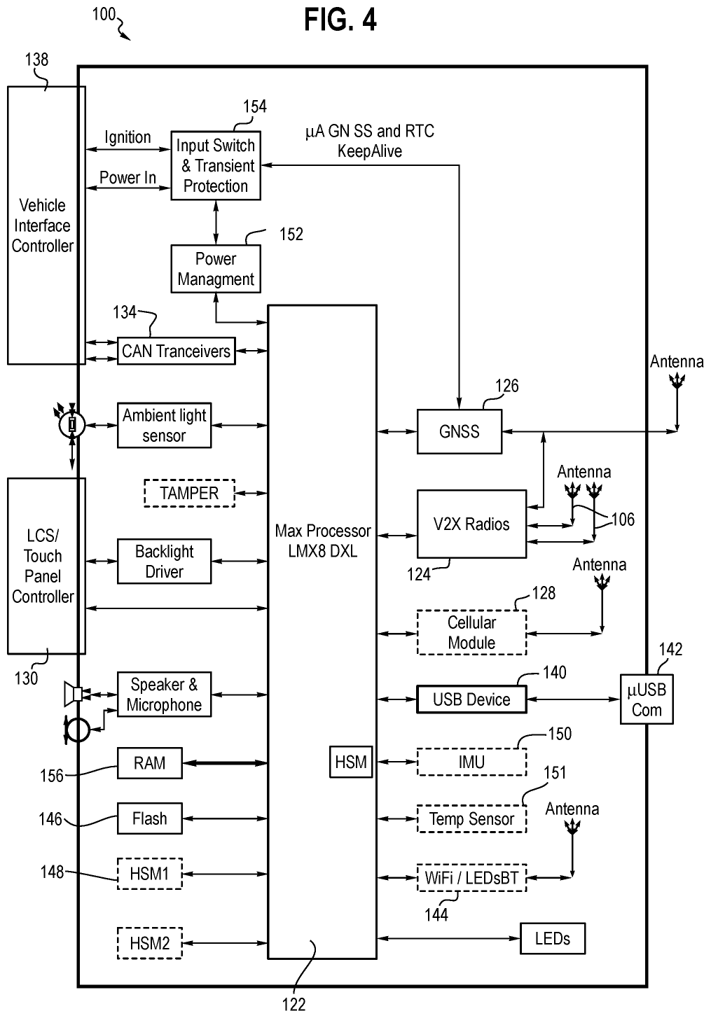

FIG. 4 is a block diagram of the vehicle communication system 100 located inside the vehicle 10. The system 100 includes the housing 104 configured to surround and protect system components including a main processor 122. The system 100 includes a V2X radio controller 124 configured to generate signals in the DSRC or CV2X protocol. The system 100 further includes a GNSS receiver unit 126 configured to translate messages to and from the GNSS protocol for the main processor 122 including a global positioning system (GPS) function for the position of the vehicle. Each of the V2X and GNSS signals is designed for the particular frequency ranges related to the different signal type. DSRC and CV2X are used as communications of the vehicle messages to other vehicles for safety applications. The processor 122 sends Basic Safety Message (BSM) format communications. Such messages include physical location, acceleration/deceleration rate, and/or direction of vehicles.

The system 100 also includes a 3G, 4G, or 5G cellular module 128 located within the housing 104. For example, 5G is the fifth-generation technology standard for broadband cellular network and is achieved partly by using additional higher-frequency radio waves in addition to the low- and medium-band frequencies used in previous cellular networks (3G and 4G). Accordingly, for providing a wide range of services, 5G networks can operate in three frequencies such as low, medium, and high frequencies. The processor 122 communicates to remote systems through the cellular module 128. The antenna for the cellular module 128 may be located within the housing 104. Windows in the housing 104 align with the antenna for the cellular module 128. Information communicated through the cellular module 128 is to update software or settings on the processor 122. In some implementations, data collected from the internal sensors, a GPS module or collected from the vehicle 10 (e.g. through the ODB port) can be communicated with a remote system through the cellular module 128.

The processor 122 communicates with an HMI unit 130 to provide information to a driver and receive information from a driver and/or user of the vehicle 10. Further, a CAN communication bus interface 134 controls communications between the main processor 122 and external units (e.g., an ODB interface connector (a vehicle interface connector) 138, or other various communication protocols (e.g., WiFi). For example, the main processor 122 communicates with the vehicle 10 via the ODB connector 138 or via a vehicle HMI display 130, for example over a CAN or LIN bus. Further, when the infotainment system of the vehicle 10 is accessed, the main processor 122 communicates with a HMI unit (a display, a speaker, or a microphone) pre-installed in the vehicle infotainment system for providing or receiving information from the driver or user. In addition, the main processor 122 may electrically communicate with a speaker and microphone unit 156 to provide and receive information between the user and the vehicle communication system 100.

The main processor 122 also communicates with Ethernet, USB interfaces 140 which provide Ethernet or USB connector 142 through the housing 104 of the vehicle communication device 102. The Ethernet, WiFi, or USB is used to download software updates, configuration updates, or data updates (e.g., Maps). Further, the USB connector 142 is used to connect WiFi, Ethernet or Bluetooth dongles (e.g., that contain WiFi, Bluetooth, or Ethernet hardware that connect to the processor through the USB port 142). The Ethernet port is also used for testing and diagnostics of the system 100.

In some implementations, a CAN bus is connected between the mounted housing 104 and an external HMI unit 130 or OBD pluggable unit 138 via a cable (not shown). In such an implementation, the cable includes a CAN HIGH connection and a CAN LOW connection. The cable includes a power HIGH connection and a power LOW connection. In other implementations, a wireless connection is used to communicate with the HMI or ODB unit. In such a scenario, power is provided to the mounted housing 104 by a battery which is within the housing 104. The battery is charged via a power connection to a utility outlet in the vehicle or a solar panel integrated within or connected to the mounted housing 104.

The vehicle communication system 100 also includes a Bluetooth interface 144 (a wireless coupler) within the housing 104. The Bluetooth module is used to connect an HMI, for example, the Bluetooth is used to connect to an app on a vehicle entertainment system, or a phone or tablet of the driver or passenger within the vehicle 10. The apps include display of information related to safety, forward collision warning, hard braking, collision detection, construction warnings, oversized vehicle warnings, overpass warning, lane change warnings, and red light violation warnings. The processor 122 is in communication with a memory 146, which includes random access memory, electronic programmable memory, solid state memory, or even removable memory such as SD cards. The processor 122 is also in communication with a hardware security module (HSM) 148 for encoding data that is transmitted to or from the processor 122.

The main processor 122 is in communication with an inertial measurement unit (IMU) 150 to collect and process information about the vehicle movement, location, position, and orientation. The IMU 150 includes MEMS inertial and/or crash sensors. As such, as acceleration in the x, y, or z axis of the vehicle as well as yaw, roll, and pitch of the vehicle. Further, the main processor 122 is in communication with a temperature sensor unit 151 to measure and process temperature information about the inside and/or outside of the vehicle 10.

Since the vehicle communication system 100 is located remotely on the windshield, dashboard, or parcel shelf inside the vehicle 10, power management is an important aspect of the system control. The processor and other protocols is powered through a power management circuit 152. The power management circuit 152 communicates with a step down voltage regulator to adjust power provided from the vehicle to power the processors and peripherals. Further, the power management circuit 152 is communicated with an input switch and transient protection unit 154 to limit the voltage amplitude, current amplitude or transition times on the circuit for protection. In a similar manner, the power management circuit 152 is in communication with linear voltage regulators for controlling power to the main processor and peripheral devices as appropriate. In some implementations, the power management circuit 152 is configured to enter a power saving mode (e.g., shut down certain modules such as sensors, communications or processors, enter low power mode for certain modules such as sensors, communications, or processors, or reduce clock speeds) in response to inertial sensing, based on communication from the processor. In addition, the electronics within the housing 104 is in the form of a stack of printed circuit board (PCB) as described above.

Locating the processor and sensors in the housing 104 mounted to the windshield provides various advantages. For example, in a centrally located processor, two RF cables would be routed to the mounted device 102 such that there is both performance and cost benefits to incorporating the processor and sensing units into the mounted housing 104.

The vehicle communication system 100 is used for radio frequency transmission of a radio frequency signals through the window of the vehicle 10 because the V2X antenna 106 enclosed by the housing 104 is located inside the vehicle 10. The window of the vehicle 10 is made of glass, polycarbonate, or other materials, and the system 100 is configured to generate a radio frequency signal between the range of 5.70 and 5.95 GHz. The signal is for a variety of applications including Vehicle to Vehicle (V2V), Vehicle to Infrastructure (V2I), Vehicle to Pedestrian (V2P), Vehicle to Cloud (V2C) or in simple for Vehicle to Everything (V2X) communication, for example, for safety applications.

The methods, devices, processors, modules, engines, and logic described above may be implemented in many different ways and in many different combinations of hardware and software. For example, all or parts of the implementations may be circuitry that includes an instruction processor such as a Central Processing Unit (CPU), microcontroller, or a microprocessor, an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry includes discrete interconnected hardware components and/or is combined on a single integrated circuit die, distributed among multiple integrated circuit dies, or implemented in a Multiple Chip Module (MCM) of multiple integrate circuit dies in a common package, as examples.

The circuitry further includes or accesses instructions for execution by the circuitry. The instructions is stored in a tangible storage medium that is other than a transitory signal, such as a flash memory, a Random Access Memory (RAM), a Read Only Memory (ROM), a Erasable Programmable Read Only Memory (EPROM); or a magnetic or optical disc, such as a Compact Disc Read Only Memory (CDROM), Hard Disk Drive (HDD), or other magnetic or optical disk; or in or on another machine-readable medium. A product, such as a computer program product, includes a storage medium, and instructions stored in or on the medium, and the instructions when executed by the circuitry in a device cause the device to implement any of the processing described above or illustrated in the drawings.

The implementations is distributed as circuitry among multiple system components, such as among multiple system components, such as among multiple processors and memories, optionally including multiple distributed processing systems. Parameters, databases, and other data structures is separately stored and managed, is incorporated into a single memory or database, is logically and physically organized in many different ways, and is implemented in many different ways, including as data structures such as linked lists, hash tables, arrays, records, objects, or implicit storage mechanisms. Programs is parts (e.g., subroutines) of a single program, separate programs, distributed across several memories and processors, or implemented in many different ways, such as in a library, such as a shared library (e.g., a Dynamic Link Library (DLL)). The DLL, for example, stores instructions that perform any of the processing described above or illustrated in the drawings, when executed by the circuitry.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for vehicle communications of a vehicle, the system comprising:
a housing;
a processor for generating and receiving communication messages external to the vehicle;
a Vehicle to Everything (V2X) transceiver electrically connected to the processor, the V2X transceiver in communication with the processor to transmit and receive the communication messages for a V2X communication; and
at least one antenna electrically connected to the V2X transceiver to transmit and receive radio frequency (RF) signals outside the vehicle,
wherein the at least one V2X antenna is arranged in the housing located in an interior side of the vehicle.

2. The system of claim 1, wherein the at least one V2X antenna is placed and enclosed in the housing.

3. The system of claim 1, wherein the housing is mounted to a front windshield or on a top surface of a dashboard inside the vehicle.

4. The system of claim 1, wherein the housing is mounted to a rear windshield or on a top surface of a parcel shelf inside the vehicle.

5. The system of claim 1, wherein the processor is located inside the housing and configured to communicate with externals to the vehicle through the at least one antenna located inside the housing.

6. The system of claim 1, wherein a central process unit (CPU) of the vehicle is used as the processor of the vehicle communication device such that the V2X antenna transceiver is communicated with an external electronic control unit (ECU) in the CPU as the processor.

7. The system of claim 1, wherein the housing further includes a second antenna such that the processor is electrically connected to a second transceiver configured to communicate messages from the second antenna to a wireless connection with an infotainment system of the vehicle.

8. The system of claim 7, wherein the wireless connection with the vehicle infotainment system is over a Bluetooth connection and/or a Wi-Fi connection.

9. The system of claim 1, further comprising a vehicle interface connector formed in the housing, the interface connector configured to communicate with an infotainment system of the vehicle via a wired connection.

10. The system of claim 1, wherein the processor is configured to generate the RF signals within frequency ranges of 5.70 and 5.95 GHz.

11. The system of claim 1, wherein the housing further includes a display for communicating with a user.

12. The system of claim 1, wherein the system further includes a Global Navigation Satellite System (GNSS) antenna arranged in the housing, and the GNSS antenna is configured to be operable for receiving and transmitting GNSS signals.

13. The system of claim 1, wherein the system further includes a cellular Long Term Evolution (LTE) antenna arranged in the housing, and the cellular LTE antenna is configured to be operable for receiving and transmitting cellular LTE signals.

14. The system of claim 1, wherein the system further includes a 4G or 5G cellular module arranged in the housing, and the 4G or 5G cellular module is configured to be operable for receiving and transmitting cellular 4G or 5G signals.
